(19) United States
(12) Patent Application Publication
(10) Pub. No.: US 2009/0063745 A1
(43) Pub. Date: Mar. 5, 2009

(54) DETACHABLE INTERFACE DEVICE FOR POWERING PORTABLE DATA PROCESSING SYSTEM USING A VEHICLE DIAGNOSTIC PORT

(75) Inventors: Dan O. Morris, Troy, MI (US); Gordon F. Schmeisser, Santa Cruz, CA (US)

Correspondence Address: MCDERMOTT WILL & EMERY LLP, 600 13TH STREET, N.W., WASHINGTON, DC, 20005-3096, US

(73) Assignee: IDSC Holdings, LLC, Kenosha, WI (US)

(21) Appl. No.: 11/849,212

(22) Filed: Aug. 31, 2007

(51) Int. Cl. G06F 13/14

(52) U.S. Cl. 710/304

(57) ABSTRACT

A interface device for powering a data processing system using an output of a vehicle diagnostic port, such as an OBD II connector, that outputs self-diagnostic information. The vehicle diagnostic port is disposed on, and an integral part of, a vehicle. The interface device includes a first connector, a second connector and a power converter. The first connector is configured to detachably couple to the vehicle diagnostic port to receive output signals therefrom. The output signals of the vehicle diagnostic port include a vehicle power output and a diagnostic output including self-diagnostic information. The second connector is configured to detachably couple to a docking connector of the data processing system. The power converter, coupled to the first connector and the second connector, is configured to generate a regulated voltage based on the vehicle power output of the vehicle diagnostic port. The regulated voltage is provided to power the data processing system.

### TECHNICAL FIELD

This application relates to a co-pending patent application Ser. No. ______ (attorney docket No. 66396-0391), entitled DETACHABLE IMPACT PROTECTION SYSTEM FOR PORTABLE DATA PROCESSING SYSTEM, filed concurrently herewith.

### TECHNICAL FIELD

This disclosure relates to techniques and equipment for powering portable data processing systems performing vehicle diagnosis, and more specifically, to a detachable interface device that powers portable data processing systems using an output of a vehicle diagnostic port that outputs self-diagnostic information.

### BACKGROUND

Increasingly, portable data processing systems, such as tablet PCs or notebook computers, are widely utilized in measuring, testing and/or diagnosing a wide range of vehicle conditions. Signals from vehicles and/or other sources, like other diagnostic systems, are input to these data processing systems for further analysis. For instance, a vehicle compliant with OBD (on-board diagnostics) standard would be equipped with a signal port, such as an OBD II port, for outputting self-diagnostic information performed by an on-board computer on the vehicle. The self-diagnostic information may be used by a notebook computer with an appropriate vehicle interface circuit and software to perform vehicle diagnostics.

As these computers often are used in garages or vehicle maintenance centers where power supply cords connecting to the systems tend to pose safety hazards, these computers are often powered by batteries internal to the computers. However, the battery in a notebook computer usually lasts only about two to four hours. Once the battery power is completely drained, the battery needs to be replaced and recharged. The power outage or replacement of batteries disrupts the diagnostic process and sometimes causes hours of work or data to be lost.

Accordingly, it is desirable to extend the power-up time of the computers without being limited by the capacity of the computer batteries.

### SUMMARY

This disclosures describe detachable power supply interface devices that provide power to data processing systems engaged in vehicle diagnosis, without the need to add extra power cords connecting to the data processing systems.

An exemplary power supply interface device according to this disclosure supplies power to a data processing system using an output of a vehicle diagnostic port, such as an OBD II connector, that outputs self-diagnostic information. The data processing system is external to a vehicle and performs vehicle diagnostics based on signals from the vehicle or other diagnostic devices. The interface includes a first connector, a second connector and a power converter. The first connector is configured to detachably couple to the vehicle diagnostic port to receive output signals therefrom. The output signals of the vehicle diagnostic port include a vehicle power output and a diagnostic output including self-diagnostic information. The second connector is configured to detachably couple to a docking connector of the data processing system. The power converter, coupled to the first connector and the second connector, is configured to generate a power supply signal, such as a regulated voltage, based on the vehicle power output of the vehicle diagnostic port. The power supply signal or the regulated voltage is provided for powering the data processing system via the second connector.

In one aspect, the power supply interface includes a protection circuit that continuously monitors the current that the data processing system is drawing from the vehicle diagnostic port. If the protection circuit detects that the drawn current exceeds a safety threshold, the protection circuit suspends the supply of power to the data processing system by the power supply interface, to prevent the high level of current from damaging circuits or parts of the vehicle. For instance, the protection circuit decouples the power supply signal or the regulated voltage from the second connector, such that the data processing system stops drawing power from the vehicle.

In another aspect, the exemplary power supply interface further includes a third connector configured to receive power from a vehicle power output connector disposed on the vehicle, such as the cigarette lighter connector or a DC power outlet. In still another aspect, the exemplary power supply interface may include an AC connector, such as an AC adaptor, configured to provide DC power from an AC power source external to the interface. For instance, the AC power source may be a regular power outlet or a vehicle alternator output. The power converter may be implemented with the capacity to convert both AC and DC input to suitable output appropriate for powering the data processing system.

In still another aspect, the exemplary power supply interface includes a housing on which the first connector and the second connector as well as other parts are disposed. The housing includes a surface for supporting the data processing system, a latch configured to secure the data processing system when the data processing system is supported by the surface; and four corner guards disposed at four corners of the housing. The corner guards form a cushioning wall for four corners of the data processing system when the data processing system is supported by the surface. In one embodiment, the housing further includes two handles disposed on two opposite sides. Each handle may include an arched body having two ends, and at least one of the ends is pivotally mounted to the housing via a hinge device. The surface of the housing may form a depth for receiving the data processing system.

Additional objects, advantages and novel features will be set forth in part in the description which follows, and in part will become apparent to those skilled in the art upon examination of the following and the accompanying drawings or may be learned by production or operation of the examples. The objects and advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitations. In the figures, like reference numerals refer to the same or similar elements.

FIG. 1 is a perspective view of an exemplary power supply interface implemented as a protective docking system.

FIG. 2 shows a notebook computer connected with the protective docking system shown in FIG. 1.

FIG. 3 the bottom view of the protective docking system illustrated in FIG. 1.

FIG. 4 depicts a schematic circuit diagram of an exemplary power supply interface.

FIG. 5 shows another embodiment of a power supply interface implemented as an external adapter for connecting to a notebook computer and a vehicle signal port.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The section describes embodiments of detachable interface devices for powering a data processing system by using an output of a vehicle diagnostic port, such as an OBD II connector, that outputs self-diagnostic information.

On-Board Diagnostics, or OBD, refers to a vehicle's self-diagnostic and reporting capability. A vehicle compliant to OBD standards includes an on-board diagnostic system that performs self-diagnosis and allows a repair technician access to the state of health information via a standardized diagnostic port. In some cases, diagnostic trouble codes (DTCs) are provided through the standardized diagnostic port to indicate operation conditions of various subsystems of a vehicle. The OBD-II standard is a type of OBD standard that specifies the type of diagnostic connector, its pinout and the available electrical signaling protocols, and the messaging format. The OBD-II specification provides for a standardized hardware interface: a female 16-pin (2×8) J1962 connector, called an OBD II connector, for outputting DTCs. Under the OBD-II standard, pin 16 is dedicated to a battery output (ranging from +9 volt to +16 volt) supplied by a vehicle battery, and pin 4 is provided for chassis ground and is the negative power connection to the vehicle. Embodiments of this disclosure utilize the vehicle power included in the output of the vehicle diagnostic port to power a data processing system and relay diagnostic information output by the vehicle diagnostic port to the data processing system for performing vehicle diagnostics. While there are numerous variations in vehicle diagnostic port standards, it is understood that as long as the output of the vehicle diagnostic port includes vehicle power supplied by a vehicle battery and/or alternator, concepts disclosed in this disclosure could be utilized to provide power to any system that requires electricity for operation.

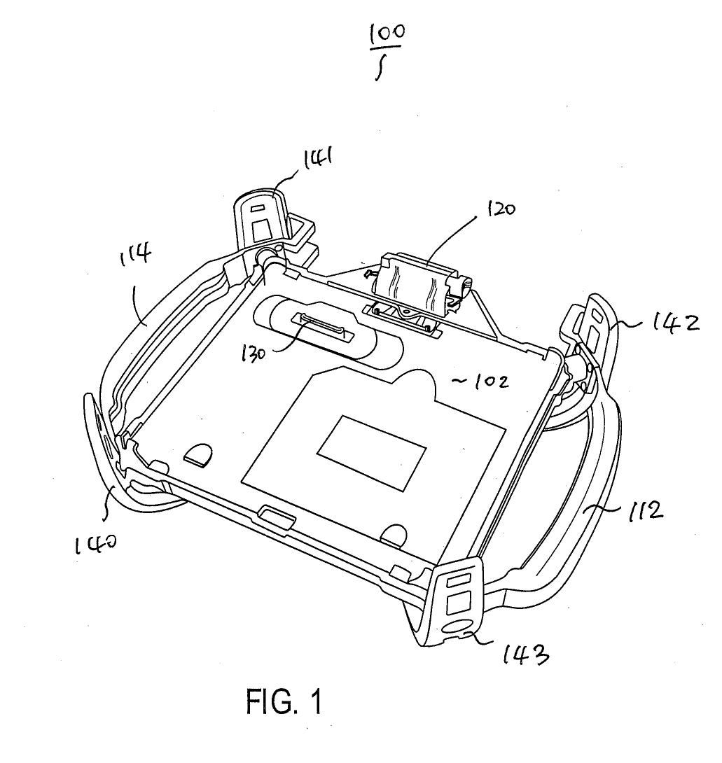

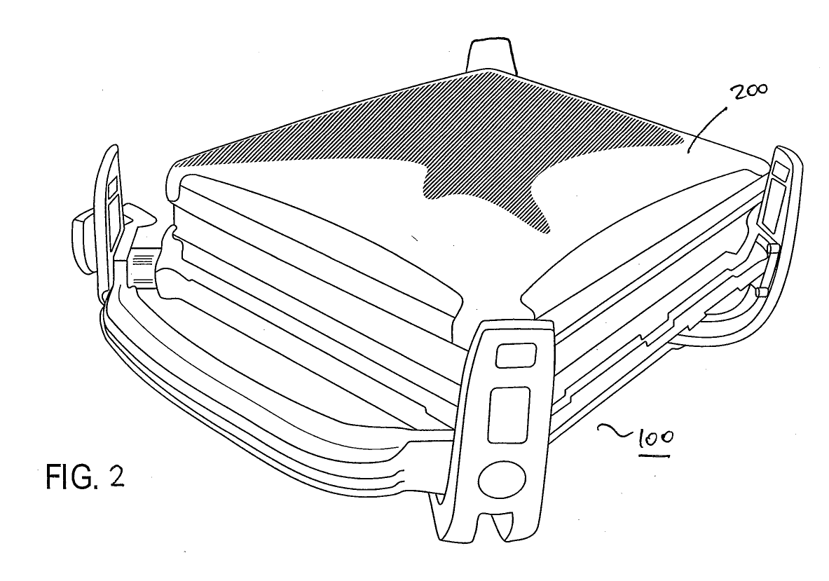

FIG. 1 depicts an exemplary power supply interface implemented as a detachable protective docking system 100 configured to connect to a notebook computer external to a vehicle, for performing vehicle diagnostics. FIG. 2 shows the docking system 100, external to the vehicle, with an attached notebook computer 200. The docking system 100 provides shock protection to the notebook computer 200, and interfaces between the notebook computer 200 and a vehicle diagnostic port, such as an OBD-II (on-board diagnostic) connector, that outputs self-diagnostic information, and at the same time supplies power to the notebook computer 200 utilizing the output of the vehicle diagnostic port.

As shown in FIG. 1, the docking system 100 includes a surface 102 for supporting the notebook computer 200, two arched handles 112, 114 attached to the body of the docking system 100, a latch 120 for securing the notebook computer 200 when the computer 200 is supported by the surface 102, and a system connector 130 disposed on the surface 102 for connecting to a matching docking connector disposed on the notebook computer 200 and forming a signal path between the docking system 100 and the notebook computer 200. Four corner guards 140-143, protruding from four corners of the docking system 100, provide a barrier or cushioning wall for protecting corners of the notebook computer 200 in case the notebook computer 200 and docking system 100 are dropped on a hard surface.

The parts of the docking system 100 are made of materials that provide shock protection to the docking system 100 and the notebook computer 200 by means of elasticity, shape deformation and/or shock absorbance and deflection, when the notebook computer 200 and the docking system 100 are dropped to a hard surface. Examples of materials for implementing the parts of the docking system 100 include spring steel coated or overmolded with rubber, semi-flexible plastics such as Nylon, Polyethylene, PVC, etc., elastomeric (rubber-like) materials such as TPE, neoprene or EPDM, etc., and metals such as spring tempered steel or stainless steel, heat treated aluminum, spring tempered brass, beryllium copper or phosphor bronze in various forms or shapes, such as in strip or wire form. These materials could be in solid or foam rubber form. The parts may have a coating applied thereto by dipping or spraying with a flexible material such as plastisol PVC.

The use of shock absorbing materials in combination with the unique shape and construction of the handles 112, 114 and corner guards 140-143 protect both the docking system 100 and the notebook computer 200 from impact damages if they are dropped onto a hard surface. The elasticity and shape deformation provided by the docking system 100 allows the shock force to be transformed to heat or other types of energy, and deflected from the notebook computer 200. For instance, when the docking system 100 and notebook computer 200 are dropped, it is the handles 112, 114, edges or sides of the docking system 100, and/or the corner guards 140-143 that would come into contact with hard surface first, not the notebook computer 200 itself. In addition, as the parts of the docking system 100 is made of materials that would provide shock absorbance and/or shock deflection through shape deformation, the drop would not impact the notebook computer 200 directly. Additionally, the elasticity of the handles 113, 114 and/or the corner guards 140-143 allow the docking system 100 and the notebook computer 100 to bounce, which reduces the impact energy being transmitted to the notebook computer 200.

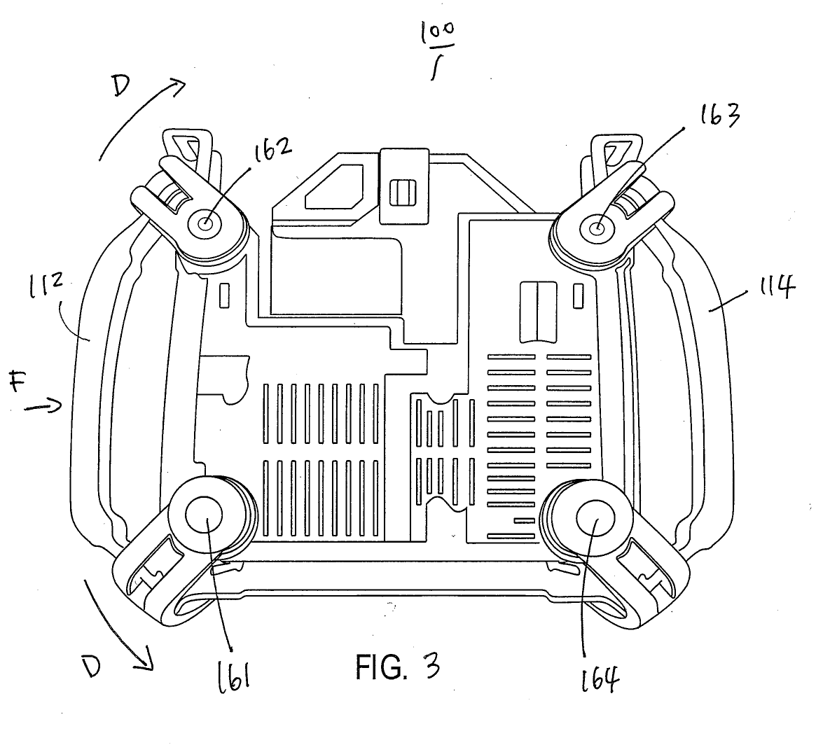

FIG. 3 is the bottom view of the docking system 100 illustrated in FIG. 1. As shown in FIG. 3, handles 112, 114 are pivotally attached to the body of the docking system 100 with hinges 161-164. When the docking system 100 is dropped and one of the handles is subject to a shock force as indicated by arrows F in FIG. 3, the elasticity of the handle allows the handle to deform to absorb or deflect the force. In addition, the hinges attached to the handle further encourage or promote deformation and shifting movement of the handles towards the directions indicated by the arrows D in FIG. 3, to assist absorbance or deflection of the shock force. In one embodiment, a handle includes only one hinge for pivotally attaching to the body of the docking system 100.

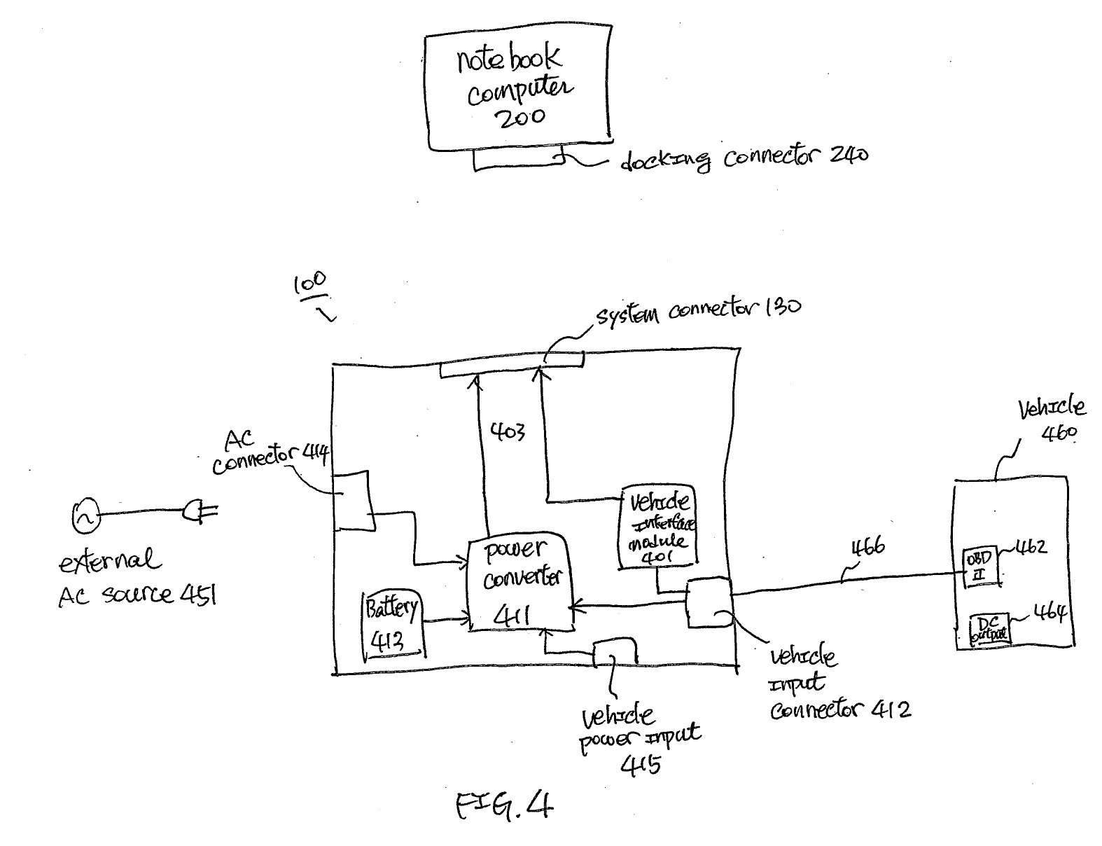

As discussed earlier, the docking system 100 is configured to power the notebook computer 200 using an output of a vehicle diagnostic port, such as an OBD 11 connector, that outputs self-diagnostic information. FIG. 4 is a schematic circuit diagram of the docking system 100 shown in FIG. 1. As depicted in FIG. 4, the docking system 100 includes a system connector 130 for connecting to a matching docking connector 240 disposed on the notebook computer 200 when the notebook computer 200 is docked on the docking system 100. The docking connector 240 and the system connector 130 form a signal path between the docking system 100 and the notebook computer 200. A vehicle input connector 412 is provided for connecting to an OBD II connector 462 disposed on a vehicle 460, via an OBD II data cable 466. The vehicle 460 further includes one or more DC output connector 464, such as a cigarette lighter connector or a 12 volt output connector that are commonly available on many vehicle. In one embodiment, the docking system 100 includes a vehicle power input connector 415 for receiving power from a vehicle power connector other than the OBD II connector 462.

In one embodiment, the docking system 100 provides an AC connector 414 for receiving power from an external AC source 451, such as a regular AC power outlet or an alternator output of the vehicle. The power supplied by the external AC source 451 may be converted to DC power by an adapter external to the docking system 100 or a power converter circuit internal to the docking system 100. The docking system 100 may include a battery back 413 to provide DC power to the docking system 100 and/or to the notebook computer 200.

A power converter 411 is provided to process power inputs from the AC connector 414, the battery 413, the vehicle input connector 412 and/or the vehicle power input connector 415, and generate a power output signal, such as an output voltage 403, suitable for powering the notebook computer 200. For instance, the DC voltage from pin 16 of the OBD II connector 462 has a range between +9 volt and +16 volt. The power converter 411 is a DC-to-DC converter that converts the DC voltage from the OBD II connector 462 to a +16 volt DC output which is suitable for powering the notebook computer 200. In another embodiment, the power converter 411 includes an AC-to-DC converter that converts an AC power signal to a DC signal that is appropriate for use by the notebook computer 200. The output voltage 403 is routed to the system connector 130 for relaying to the notebook computer 200 via the connection of the system connector 130 and the docking connector 240 on the notebook computer 200. The system connector 130 and the docking connector 240 on the notebook computer specifically define a power supply pin or port, such that the output voltage 403 is properly routed to appropriate circuit in the notebook computer 200 for powering the notebook computer 200 and/or charging a battery disposed in the notebook computer 200. Power converters suitable for implementing the power conversion herein may be obtained from Lind Electronics of Minneapolis, Minn.

The docking system 100 includes a protection circuit to prevent situations where the notebook computer 200 is drawing excessive current from the vehicle, which might damage parts and/or circuits of the vehicle. The protection circuit includes a current sensor that continuously monitors a current drawn by the notebook computer 200 from the OBD II connector 462 or a current being supplied to the notebook computer 200. A microcontroller may be provided to determine whether the detected current exceeds a safety threshold. If such safety threshold is exceeded, the microcontroller issues a control signal to terminate supplying power from the OBD II connector 462 to the notebook computer 200. For instance, a switch may be provided to decouple the output voltage 403 from the system connector 130, such that the output voltage 403 ceases to power the notebook computer 200. Once the detected current drops below the safety threshold, the microcontroller issues another control signal to reengage the output voltage 403 with the system connector 130. This protection circuit may be implemented as part of the power converter 411 or as a separate circuit disposed on a circuit board disposed in the housing of the docking system 100. It is understood that other variations of circuit design other than those described herein may be used to implement the protection circuit.

Generally, the communications protocols supported by OBD are not compatible to various standards adopted the notebook computer 200. The docking system 100 includes a vehicle interface module (VIM) 401 for converting diagnostic signals output by the OBD II connector 462 to a protocol supported by the notebook computer 200, such as the USB standard, and enabling communications between the notebook computer 200 and electronic control units (ECUs) on the vehicle 460, such that diagnostic information, like DTCs, can be recognized and/or processed by the notebook computer 200, and commands issued by the notebook computer 200 can be recognized by the ECUs on the vehicle. In one embodiment, the vehicle interface module is external to the docking system 100 and is powered by a DC output from the docking system 100. The power may be provided by the battery 413 or by the OBD II connector 462.

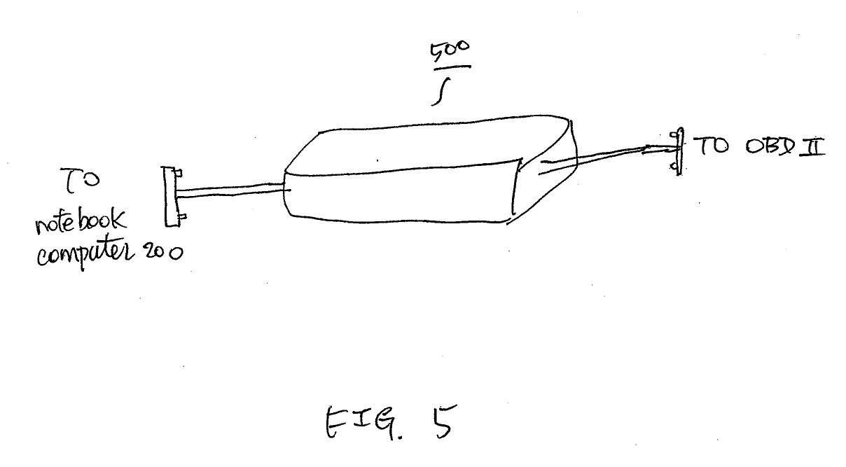

FIG. 5 depicts another embodiment of an exemplary interface device implemented as an adapter 500 external to a vehicle and the notebook computer 200, for interfacing between the notebook computer 200 and the OBD II connector 462. The adapter 500 includes a housing for receiving the parts described earlier relative to FIGS. 1-4. To avoid redundancy, descriptions of parts having the same reference numbers discussed earlier are omitted. The OBD II connector 462 and the notebook computer 200 connect to the adapter 500 via data cables. Similar to the docking system described with respect to FIGS. 1-4, the adapter 500 powers the notebook computer 200 by converting the vehicle power included in the output of the OBD II connector 462 to a +16 volt DC voltage. Diagnostic information embedded in the output of the OBD II connector 462 are processed by the adaptor 500, for conversion to a format compatible to that used by the notebook computer 200.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A power supply interface for powering a data processing system using an output of a vehicle diagnostic port disposed on a vehicle, wherein the vehicle diagnostic port is configured to output self-diagnostic information, the interface comprising:
a first connector configured to detachably couple to the vehicle diagnostic port to receive output signals from the vehicle diagnostic port, wherein the output signals of the vehicle diagnostic port include a vehicle power output and a diagnostic output including self-diagnostic information;
a second connector configured to detachably couple to a docking connector of the data processing system;
a power converter, coupled to the first connector and the second connector, configured to generate a power supply signal based on the vehicle power output of the vehicle diagnostic port;
wherein when the power supply interface couples to the vehicle diagnostic port via the first connector and to the docking connector of the data processing system via the second connector, the power supply interface supplies power to the data processing system using the power supply signal.

2. The power supply interface of claim 1, wherein the second connector, when coupled to the docking connector of the data processing system, establishes a charging path coupling the power supply signal to a battery of the data processing system, and charges the battery of the data processing system using power supply signal.

3. The power supply interface of claim 1, wherein the power output of the vehicle diagnostic port is provided by a battery of the vehicle.

4. The power supply interface of claim 1 further comprising a third connector configured to receive power from a vehicle power output connector disposed on the vehicle, wherein the power output connector is a connector different from the vehicle diagnostic port.

5. The power supply interface of claim 1 further comprising an AC connector configured to receive an AC power signal provided by an AC power source external to the vehicle.

6. The power supply interface of claim 5, wherein the AC connector is coupled to the power converter, and the power converter converts the AC power signal to the power supply signal.

7. The power supply interface of claim 1, wherein both the vehicle power output and the power supply signal are DC signals.

8. The power supply interface of claim 1 further comprising a housing, wherein:
the first connector and the second connector are disposed on the housing; and
the housing includes:
a surface for supporting the data processing system;
a latch configured to secure the data processing system when the data processing system is supported by the surface; and
four corner guards disposed at four corners of the housing, wherein the corner guards form a cushioning wall for four corners of the data processing system when the data processing system is supported by the surface.

9. The power supply interface of claim 8, wherein the housing further includes two handles disposed on two opposite sides of the housing.

10. The power supply interface of claim 9, wherein each handle has an arched body having two ends, at least one of the ends is pivotally mounted to the housing via a hinge device.

11. The power supply interface of claim 8, wherein the surface of the housing forms a depth for receiving the data processing system.

12. The power supply interface of claim 1, wherein:
the first connector connects to the power supply interface via a first connector cable; and
the second connector connects to the power supply interface via a second connector cable.

13. The power supply interface of claim 1 further comprising a battery pack for supplying power to the data processing system.

14. The power supply interface of claim 1 further comprising a protection circuit including a current sensor for detecting a current being supplied by the vehicle diagnostic connector, and a control circuit configured to terminate the power supply signal being supplied to the data processing system, if the detected current exceeding a safety threshold.

15. The power supply interface of claim 14, wherein the control circuit resumes conveyance of the power supply signal to the data processing system, if the detected current falls within the safety threshold.

16. A method for supplying power to a data processing system using an output of a vehicle diagnostic port disposed on a vehicle, wherein the vehicle diagnostic port is configured to output self-diagnostic information, the method comprising:
receiving output signals from the vehicle diagnostic port, wherein the output signals of the vehicle diagnostic port include a vehicle power output and a diagnostic output including self-diagnostic information;
generating a power supply signal based on the vehicle power output of the vehicle diagnostic port;
supplying the power supply signal to the data processing system.

17. The method of claim 16, wherein the second connector, when coupled to the docking connector of the data processing system, establishes a charging path coupling the power supply signal to a battery of the data processing system, and charges the battery of the data processing system using power supply signal.

18. The method of claim 16 further comprising:
detecting an attribute of the power supply signal or the vehicle power output;
determining whether the attribute of the power supply signal or the vehicle power output meets a predetermined safety requirement;
if the attribute fails to meet the predetermined safety requirement, terminating conveyance of the power supply signal to the data processing system; and
if the attribute returns to a value that meets the predetermined safety requirement, resuming conveyance of the power supply signal to the data processing system.

19. A power supply interface for sending power to a data processing system using an output of a vehicle diagnostic port disposed on a vehicle, wherein the vehicle diagnostic port is configured to output self-diagnostic information, the interface comprising:
first connecting means for detachably coupling to the vehicle diagnostic port to receive output signals from the vehicle diagnostic port, wherein the output signals of the vehicle diagnostic port include a vehicle power output and a diagnostic output including self-diagnostic information;
second connecting means for detachably coupling to a docking connector of the data processing system;
power converting means, coupled to the first connecting means and the second connecting means, for generating a power supply signal based on the vehicle power output of the vehicle diagnostic port;
wherein when the power supply interface couples to the vehicle diagnostic port via the first connecting means and to the docking connector of the data processing system via the second connecting means, the power supply interface supplies power to the data processing system using the power supply signal.

20. The power supply interface of claim 19, wherein the second connecting means, when coupled to the docking connector of the data processing system, establishes a charging path coupling the power supply signal to a battery of the data processing system, and charges the battery of the data processing system using power supply signal.

21. The power supply interface of claim 19 further comprising a third connecting means for receiving power from a vehicle power output connector disposed on the vehicle, wherein the power output connector is a connector different from the vehicle diagnostic port.

22. The power supply interface of claim 19 further comprising AC connecting means for receiving an AC power signal provided by an AC power source external to the power supply interface.

23. The power supply interface of claim 19 further comprising housing means for receiving the data processing system, wherein:
the first connecting means and the second connecting means are disposed on the housing means; and
the housing means includes:
means for supporting the data processing system;
securing means for securing the data processing system when the data processing system is supported by the supporting means; and
corner guarding means, disposed at four corners of the housing, for forming a cushioning layer for four corners of the data processing system when the data processing system is supported by the surface means of the housing means.

24. The power supply interface of claim 23, wherein the housing means further includes gripping means for being held by a user's gripping hands, and the gripping means includes two ends pivotally mounted to the housing means.

25. The power supply interface of claim 19 further comprising a protection means for selectively terminating supplying the power supply signal to the data processing system based on a predetermined safety requirement and an attribute of the power supply signal or the vehicle power output.
